(19) United States
(12) Patent Application Publication
(10) Pub. No.: US 2020/0133093 A1
(43) Pub. Date: Apr. 30, 2020

(54) Modular Photo Kiosk

(71) Applicant: Brady King, Greenville, SC (US)

(72) Inventor: Brady King, Greenville, SC (US)

(21) Appl. No.: 16/174,423

(22) Filed: Oct. 30, 2018

(51) Int. Cl. G03B 15/00

(52) U.S. Cl. CPC G03B 15/00

(57) ABSTRACT

A modular photo kiosk includes a series of lightweight panels that fit together and attach to a base member. In a preferred embodiment, the panels include a top panel, a center panel, and a bottom panel. The top panel may include on a front portion a pair of compartments, wherein the first compartment receives a camera and video screen (such as an iPad or other tablet device), and the second compartment is used to house a light. The rear of the panels may include one or more channels for receiving power cords, so that the power cords run from the compartments, down the back of the kiosk, and the cord extends from a bottom portion of the kiosk so that it may be plugged into a wall outlet. Attachment means are used to connect the panels together, and are also used to connect the bottom panel to the base member.

### BACKGROUND OF THE INVENTION

Photo booths have been popular over the years at amusement parks, fairs, and the like. More recently, businesses have begun renting out photo booths and kiosks for special events, such as weddings, parties, fundraising events, and other types of gatherings. Typically, the photo booth is set up in the venue where the party will be held, and attendees may step into the photo booth, either individually or in groups, and have their pictures made. These pictures may be digital in nature, and may be sent to a person's digital device (computer, smart phone, tablet), or they may be printed on photographic paper and fed through a slot for extraction. Oftentimes, these rental businesses are responsible for delivering the photo booth or kiosk to the venue before the party begins, setting it up for use by guests, and then returning after the party is over to retrieve the kiosk. Some businesses even include props as a part of the rental, which might include funny hats, sunglasses, magic wands, costumes, and the like.

One issue with the business model described above is that it is labor intensive, so that an employee or owner of the business must deliver the kiosk, set it up, and then disassemble it after the party and return it to the business location. The labor costs associated with this process cause the rental rates to be unnecessarily high.

Thus, it would be advantageous to provide a photo booth or kiosk that is modular in nature, so that it may be easily broken down into smaller pieces and placed into a box for shipping. Preferably, the modular photo kiosk would be made from lightweight, durable, and inexpensive material, so that it is inexpensive to ship.

There have been attempts to develop modular photo booths and kiosks, with varying levels of success. Each of the following examples has advantages and disadvantages, and the references listed below are hereby incorporated by reference herein, in their entireties:

U.S. Pat. No. 5,784,651—Photo Booth with Modular Construction

A photo booth for capturing an image of a subject and providing reproductions of the image is constructed from self-contained modules—an apparatus module and a background module-linked via a roof module and a floor member. The modules can be easily bundled for handling and storing and occupy, when bundled together, a substantially smaller floor space than when the modules are secured to each other for operation as a photo booth. The apparatus module includes an image capturing device, such as a photographic camera using self-developing film, an electronic camera or a combination thereof, and an image reproduction device and may further include means for illuminating the subject, for image processing and display and for receiving payment. Means for controlling the temperature and humidity inside the apparatus module may also be provided. The apparatus module may also be used as a stand-alone unit. Translucent panels adapted to be illuminated for displaying messages may be secured to the outside walls of the modules.

U.S. Pat. No. 7,796,869—Photobooth

A portable photobooth system includes a frame, fabric, a movable curtain, and a digital camera. The frame includes a plurality of tubular members configured to be connected together and capable of disassembly for storage and transport. The plurality of tubular members of the frame includes a substantially vertically-extending first bar and a U-shaped fitting attached to the first bar. The fabric covers at least portions of the frame to define a rectangular box-like enclosure having a doorway. The movable curtain is configured for covering the doorway. The digital camera is supported by the U-shaped fitting.

U.S. Pat. No. 7,885,522—Photo Booth Systems and Methods

Photo booth systems and methods of using photo booth systems, such as those that provide photo booths and interaction between the photo booths and one or more user groups.

U.S. Pat. No. 8,737,828—Portable Photo Booth

A portable photo booth is disclosed which emphasizes reduced size and increased portability by utilizing a two-piece case which can be quickly assembled and disassembled. When assembled, the case will expose a camera and touch screen for taking photos in series, which can then be printed using a photo printer. When disassembled, the case will provide a very secure and robust environment, protecting the internal components from the elements.

U.S. Pat. No. 8,340,511—Portable Photo Booth

A portable photo booth may be transported to various entertainment events after being disassembled into readily transportable component. The photo booth may comprise a tent-like enclosure into which 1 to 15 people may enter to be photographed. Upon arrival at an event site the enclosure may be erected and a collection of separable equipment boxes may be attached to the enclosure. The equipment boxes may contain pre-connected equipment such as a camera, a laptop computer, a monitor, a light source and a printer. After the event, the photo booth may be disassembled into readily transportable components and carried to another event.

### BRIEF SUMMARY OF THE INVENTION

In accordance with one aspect of the invention, a first embodiment of a modular photo kiosk includes a series of lightweight panel components (or “panels”) that fit together to form a vertical panel assembly, which is removably attached to a base member. In a preferred embodiment, the vertical panel assembly includes a top panel, a center panel, and a bottom panel, although it should be understood that the vertical panel assembly may include more than three panels vertically stacked on one another, or the vertical panel assembly may include less than three panels. The top panel may include on a front portion a pair of compartments, wherein the first compartment receives a camera and video screen (such as an iPad or other tablet device), and the second compartment is used to house a light. The rear of the panels may include one or more channels for receiving power cords, so that the power cords run from the compartments, down the back of the kiosk, and the cord extends from a bottom portion of the kiosk so that it may be plugged into a wall outlet.

Attachment means are used to connect the panels together, and are also used to connect the bottom panel to the base member. In a preferred embodiment, the attachment means include tubular members that extend into holes within the panels on top and bottom sides thereof. It should be understood that any suitable type of attachment means may be used.

Preferably, the panels are made of a lightweight material, such as a foam, and the modular construction is simple to assemble and disassemble.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of a modular photo kiosk, having a vertical panel assembly comprising a top panel, a center panel, and a bottom panel attached to a base member, wherein the top panel includes a video screen and camera, along with a light;

FIG. 2 is a front view of the modular photo kiosk shown in FIG. 1;

FIG. 3 is a rear view of the modular photo kiosk shown in FIG. 1;

FIG. 4 is a front cutaway view of the modular photo kiosk shown in FIG. 2 along lines 4-4, further showing the attachment tubes extending between the panels; and

FIG. 5 is a cross-sectional side view of the modular photo kiosk shown in FIG. 1.

### DETAILED DESCRIPTION OF THE INVENTION

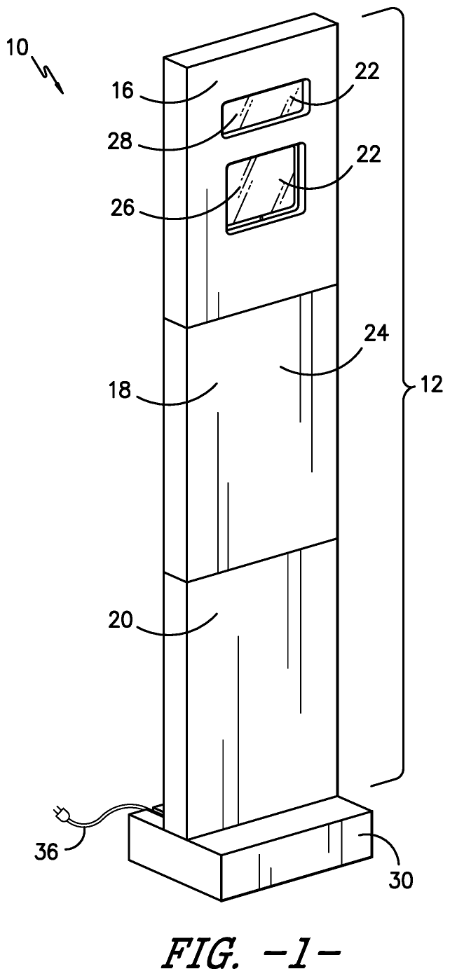

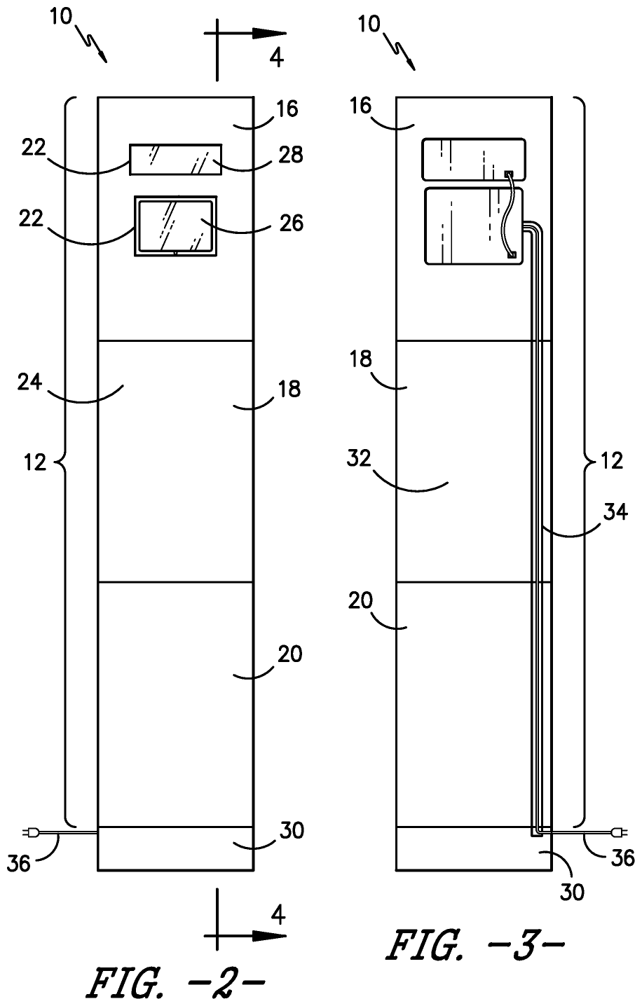

The present invention, in a first embodiment, is a modular photo kiosk 10, as shown in FIGS. 1-5. In a preferred embodiment, the modular photo kiosk includes a vertical panel assembly 12 comprising a series of panels stacked vertically, as shown, and attached by using tubular attachment members 14 that slide into holes in the top and bottom portions of the panels. The top panel 16 includes a pair of compartments 22 on a front face 24 thereof, wherein the first compartment 22 is dimensioned to receive a video screen and camera 26 (preferably in the form of an iPad or other type of digital tablet), and the second compartment 22 receives a light 28.

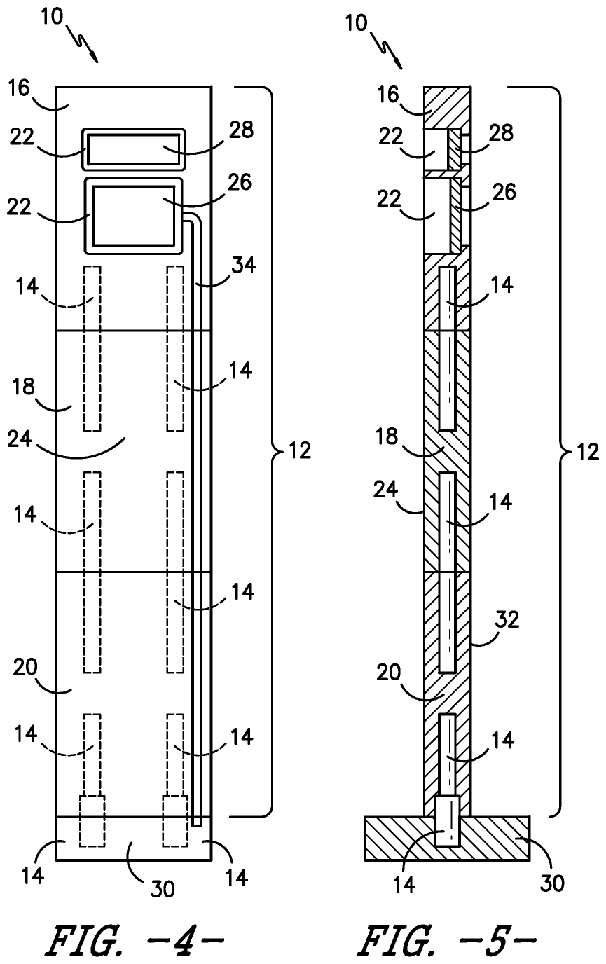

The modular photo kiosk 10 also includes a base member 30, which is used for stability in order to maintain the kiosk 10 in an upright, vertical position. In one embodiment, the base member 30 includes a pair of holes to receive a pair of attachment tubes 14. The attachment tubes 14 extend upwardly from the base member 30 when they are in position on the base member 30, and are configured to receive attachment tubes 14 of a smaller diameter, which extend upwardly into holes defined in a bottom portion of the bottom panel member 20, as shown in FIGS. 4 and 5.

The bottom panel member 20 includes a pair of holes on a bottom side thereof, for receiving the attachment tubes 14 that extend between the base member 30 and the bottom panel member 20. The top side of the bottom panel member 20 also includes a pair of holes for receiving attachment tubes 14 that extend between the bottom panel member 20 and the center panel member 18.

The center panel member 18 includes two holes on a top side thereof, and two holes on a bottom side thereof for receiving attachment tubes 14, as shown in FIGS. 4 and 5. The top panel member 16 includes a pair of holes on a bottom side thereof, for receiving attachment tubes 14 that extend between the center panel member 18 and the top panel member 16.

In one embodiment, the rear face 32 of the panels include a channel 34 for receiving the power cords 36 from the camera/video screen 26 and light 28, so that the cords 36 may run from the compartments 22 down the rear face 32 of the vertical panel assembly 12, and may extend outwardly from the bottom portion thereof, as shown in FIG. 3. Alternatively, two channels 34 may run down the rear face 32 of the vertical panel assembly 12, one channel 34 for the camera/screen power cord 36, and the other for the light power cord 36.

The modular photo kiosk 10 may be easily assembled and disassembled, so that a kiosk rental business may simply ship the disassembled kiosk 10 to the renter, and the renter may set it up for a party or event. Similarly, when the event has concluded, the renter may simply disassemble the kiosk 10, place it back into the shipping box, and ship it back to the rental business.

The panels are preferably made from a lightweight material, such as foam or more specifically, crosslink polyethylene (XLPE), and may include a decorative outer coating made from synthetic rubber, or any other suitable coating. The attachment tubes may be made from cardboard or any other lightweight, sturdy material, and it should be understood that although the invention has been described herein as using attachment tubes 14 and holes within the panels, any other suitable attachment structures may be used for assembly of the kiosk 10. The entire kiosk assembly 10, in a preferred embodiment, weighs no more than 15 pounds, and may fit into a box having the following dimensions when broken down into its component pieces: 24 inches×24 inches×24 inches.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A modular photo kiosk comprising:
a base member and a vertical panel assembly having a bottom portion, wherein said bottom portion of said vertical panel assembly is removably attached to said base member using at least one attachment structure, and wherein said vertical panel assembly includes a front face defining one or more compartments for receiving a camera and video screen.

2. The modular photo kiosk of claim 1, wherein said base member and said bottom portion of said vertical panel assembly each define one or more openings for receiving one of said attachment structures;
wherein said attachment structure is a tube having a bottom portion and a top portion;
wherein said bottom portion of said tube is received by said opening in said base member; and
wherein said top portion of said tube is received by said opening in said bottom portion of said vertical panel assembly.

3. The modular photo kiosk of claim 2, wherein said top portion of said tube includes a smaller tube extending telescopically therefrom and into an additional opening in the bottom portion of the vertical panel assembly. (Is the tube telescopic? Or is the tube just larger in diameter at one end?)

4. The modular photo kiosk of claim 1, wherein said vertical panel assembly comprises three vertically oriented panels, including a bottom panel, a center panel and a top panel;
wherein said bottom panel is removably attached to said base member, said center panel is removably attached to said bottom panel, and said top panel is removably attached to said center panel in a vertically stacked relation; and
wherein said one or more compartments are positioned on said top panel.

5. The modular photo kiosk of claim 4, wherein said base member and said bottom portions and top portions of said bottom panel and said center panel define openings for receiving one of said attachment structures, and
wherein said top panel includes one or more openings on a bottom portion thereof, so that each opening is configured to receive one of said attachment structures; and
wherein said attachment structures are tubes.

6. The modular photo kiosk of claim 1, wherein said vertical panel assembly includes a rear face having a channel running longitudinally therethrough for receiving power cords for said camera and said video screen, and
wherein said one or more compartments defines a hole extending from said compartment through said vertical panel assembly to said rear face of said vertical panel assembly, so that said power cord may extend through said hole in said one or more compartments, and said power cords may be inserted and run downwardly through said channel.

7. The modular photo kiosk of claim 1, where the front face of the vertical panel assembly has two compartments, wherein the first compartment is configured to receive a camera and video screen and the second compartment is configured to house a light.

8. The modular photo kiosk of claim 2, wherein said front face of said vertical panel assembly has two compartments, wherein the first compartment is configured to receive a camera and video screen and the second compartment is configured to house a light.

9. The modular photo kiosk of claim 5, wherein said front face of said vertical panel assembly includes two compartments, wherein a first compartment is configured to receive a camera and video screen and a second compartment is configured to house a light.

10. The modular photo kiosk of claim 1, where said base member and said vertical panel assembly are manufactured from crosslink polyethylene, and weighing no more than 15 pounds.

11. The modular photo kiosk of claim 1 that, when disassembled, may be stored in a container having dimensions no larger than 24 inches in height, 24 inches in width, and 24 inches in length.

12. An modular photo kiosk comprising:
A base member having at least one opening configured for receiving a connecting structure;
a vertical panel assembly having a front face defining at least one compartment for receiving a camera and video screen, a lower portion defining at least one opening configured for receiving a connecting structure; and
at least one connecting structure removably inserted into said opening in said base member and said opening in said lower portion of said vertical panel assembly, thereby removably connecting said base member and said vertical panel assembly.

13. The modular photo kiosk system of claim 12, where said vertical panel assembly is comprised of a series of component panels each having an upper portion and a lower portion, with such upper portions and lower portions each having one or more openings configured for receiving a connecting structure and which can be removably connected to each other by inserting connecting structures into said openings of said upper portions and lower portions and stacking said component panels vertically.

14. The modular photo kiosk of claim 13, where said connecting structures are tubes.

15. The modular photo kiosk of claim 13, where said vertical panel assembly has a rear face having an opening extending through said vertical panel assembly to said compartment contained on said front face, and further including a channel defined by said rear face, said channel being configured to carry electrical cords of electrical equipment housed in said compartment to allow plugging in said cords to electrical outlets.

16. The modular photo kiosk of claim 13, where said front face of said vertical panel assembly defines a first compartment for a camera and video screen and a second compartment for a light.

17. The modular photo kiosk of claim 13, where said base member and vertical panel assembly are constructed of lightweight foam material weighing no more than 15 pounds.

18. The modular photo kiosk of claim 13, that, when disassembled, occupies dimensions no larger than 24 inches in height, 24 inches in width, and 24 inches in length.

19. A lightweight modular photo kiosk comprising a vertical panel assembly that is removably connected to a base member, where said vertical panel assembly is comprised of a plurality of component panels that are stacked vertically edge to edge on top of each other and are removably secured to each other by connecting structures, and where said vertical panel assembly contains a plurality of compartments for housing a camera, video screen, and light.

20. The lightweight modular photo kiosk of claim 19, where the total weight of the kiosk does not exceed 15 pounds.
